(19) United States
(12) Patent Application Publication
(10) Pub. No.: US 2019/0220053 A1
(43) Pub. Date: Jul. 18, 2019

(54) Manual Interface Device for Facilitating Operator Control of a Manually Controllable System

(71) Applicant: Raytheon BBN Technologies, Corp., Cambridge, MA (US)

(72) Inventors: Zachary Eric Leuschner, Annapolis, MD (US); Gregory Vorsanger, Baltimore, MD (US); John-Francis Mergen, Baltimore, MD (US)

(73) Assignee: Raytheon BBN Technologies, Corp.

(21) Appl. No.: 16/366,441

(22) Filed: Mar. 27, 2019

Related U.S. Application Data
(62) Division of application No. 15/598,191, filed on May 17, 2017.

(51) Int. Cl. G05G 1/54; F16H 59/02; G05G 1/06

(52) U.S. Cl. CPC G05G 1/54; G05G 1/06; F16H 59/0278

(57) ABSTRACT

A manual interface device is disclosed. The manual interface device can include a first interface component attachable to a manually controllable mechanism. The first interface component can have a first interface surface defining a protrusion or a recess. In addition, the manual interface device can include a second interface component attachable to a human operator. The second interface component can have a second interface surface defining the other of the protrusion or the recess to engage with the first interface surface sufficient to transfer force to operate the manually controllable mechanism. The first and second interface components can be magnetically attracted to one another to maintain engagement of the first and second interface surfaces during operation of the manually controllable mechanism while facilitating selective disengagement of the first and second interface surfaces by the operator.

### RELATED APPLICATIONS

This is a divisional application of U.S. application Ser. No. 15/598,191, filed May 17, 2017, entitled “Manual Interface Device for Facilitating Operator Control of a Manually Controllable System” which is incorporated by reference in its entirety herein.

### BACKGROUND

A person who is permanently or temporarily disabled in an upper extremity may have lost the ability to effectively grasp and manipulate objects. This may be due to the disability itself and/or to a therapeutic apparatus for the disability. One common example is a broken wrist that requires a cast or a splint on the lower arm. Such a cast or other therapeutic apparatus on the lower arm may prevent the person from safely operating a vehicle, such as interfering with the person's ability to grasp and maneuver a gear shift or other types of levers. This physical encumbrance can therefore inhibit the person's ability to travel to work or other destinations, such as to a hospital or other care facility for treatment of the disability, and may necessitate other travel arrangements (e.g., getting rides from family and friends, utilizing public transportation, etc.), which is often inconvenient.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is an illustration of a manual interface system in accordance with an example of the present disclosure.

FIG. 2 is an illustration of an interface component of the manual interface system of FIG. 1 coupled to a structure associated with an operator, in accordance with an example of the present disclosure.

FIGS. 3A and 3B illustrate side views of a manual interface system in accordance with another example of the present disclosure.

FIG. 4A is an illustration of a manual interface system in accordance with yet another example of the present disclosure.

FIG. 4B is a top view of interface components of the manual interface system of FIG. 4A.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

An initial overview of the inventive concepts is provided below and then specific examples are described in further detail later. This initial summary is intended to aid readers in understanding the examples more quickly, but is not intended to identify key features or essential features of the examples, nor is it intended to limit the scope of the claimed subject matter.

Although people suffering from temporary or permanent disabilities to an upper extremity that limits or prevents manual operation of certain devices (e.g., a vehicle) may make alternative arrangements to deal with the disability (e.g., seeking a ride from a friend), such arrangements are often inconvenient and burdensome. Such disabled individuals can benefit from an ability to manually operate certain devices and therefore regain or maintain some degree of self-sufficiency in this regard.

Accordingly, a manual interface device is disclosed that enables a person suffering from an upper extremity disability to manually operate certain devices. In one aspect, such a person can operate the gear shift lever of a vehicle. The manual interface device can include a first interface component attachable to a manually controllable mechanism. The first interface component can have a first interface surface. In some examples, the first interface component and first interface surface can define a protrusion or a recess. In addition, the manual interface device can include a second interface component attachable to a human operator. The second interface component can have a second interface surface, and in some examples, can define the other of a protrusion or a recess operable to engage with the first interface surface in a manner sufficient to transfer force to operate the manually controllable mechanism, The first and second interface components can be magnetically attracted to one another to maintain engagement of the first and second interface surfaces during operation of the manually controllable mechanism while facilitating selective disengagement of the first and second interface surfaces by the operator.

In one aspect, a manual interface system can comprise a manually controllable mechanism, and a manual interface device. The manual interface device can have a first interface component attached to the manually controllable mechanism. The first interface component can have a first interface surface, such as one defining a protrusion or a recess. The manual interface device can also have a second interface component attachable to a human operator. The second interface component can have a second interface surface, such as one defining the other of the protrusion or the recess to engage with the first interface surface sufficient to transfer force to operate the manually controllable mechanism. The first and second interface components can be magnetically attracted to one another to maintain engagement of the first and second interface surfaces during operation of the manually controllable mechanism while facilitating selective disengagement of the first and second interface surfaces by the operator.

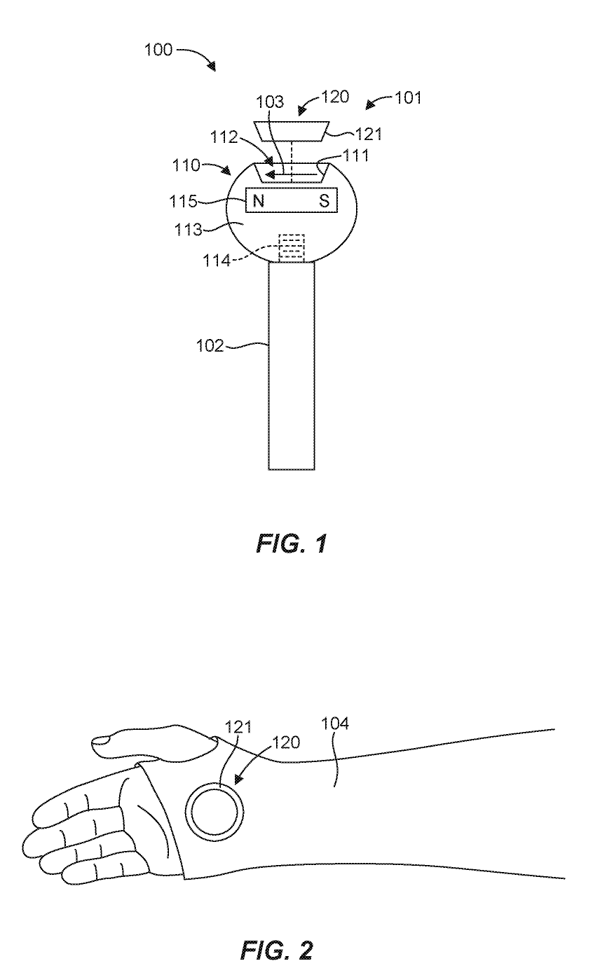

One embodiment of a manual interface system 100 is illustrated in FIG. 1. The manual interface system 100 can comprise a manual interface device 101 and a manually controllable mechanism 102. The manually controllable mechanism 102 can be any type of device or mechanism that can be controlled or manipulated by an operator. Such a device or mechanism may include a lever, a dial, a wheel, etc. that facilitates control or manipulation of the device or mechanism. In one embodiment, the manually controllable mechanism 102 can be an automobile transmission (e.g., manual shift or automatic shift), which may include a gear shift or select lever that facilitates control of the transmission. In other embodiments, the manually controllable mechanism 102 can be a tool (e.g., a hand tool). Those skilled in the art will recognize other types of manually controllable mechanisms, and such are contemplated and intended to be within the scope of the technology presented herein.

The manual interface device 101 can include an interface component 110 attachable to the manually controllable mechanism 102. The interface component 110 can have an interface surface 111. As in the example shown, the interface surface can define a recess 112, but such is not intended to be limiting in any way. The manual interface device 101 can also include an interface component 120 attachable to a human operator. The interface component 120 can have an interface surface 121. As in the example shown, the interface surface 121 can define a protrusion to engage with the interface surface 111. The interface surfaces 111, 121 can be configured in a manner, such that they operate together to transfer force (e.g., a lateral force 103) from the operator to the manually controllable mechanism 102 through the interface components 110, 120 to operate the manually controllable mechanism 102. In other words, the interface components 110, 120 can have “female” and “male” mating features at least partially defined by the interface surfaces 111, 121 that physically interface and engage with one another to enable the transfer of force (and/or torque as discussed below) from the interface component 120 to the interface component 110, which can enable the operator to manipulate and control the manually controllable mechanism 102 via the interface components 110, 120. Although the interface surface 111 is illustrated as defining a recess, and the interface surface 121 is illustrated as defining a protrusion, it should be recognized that the interface surface 111 can define a protrusion, and the interface surface 121 can define a recess. In some embodiments, the interface surfaces 111, 121 can each define a protrusion and/or a recess. In still other examples, not shown, the interface components can comprise any configuration that provides the ability for these components to interface with and engage one another to facilitate a sufficient force transfer function.

The interface component 120 can be coupled to the operator in any suitable manner. With continued reference to FIG. 1, in one aspect the interface component 120 can be attached or coupled to or otherwise supported about a structure 104, such as a therapeutic or rehabilitation apparatus (e.g., a cast, a splint, a brace, etc.), and/or a prosthetic device, which is associated with an operator as shown in FIG. 2. For example, the interface component 120 can be coupled to or otherwise supported about a suitable location of the structure 104 to facilitate engagement with the interface component 110 and control of the manually controllable mechanism 102 by the operator. The interface component 120 can be coupled to or supported about the structure 104 in any suitable manner, such as with an adhesive, a fastener, a strap, a belt, a clip, a buckle, a hook and loop fastener, etc. Or, the two can be integrally formed with one another (e.g., as a single monolithic structure), etc. In one embodiment, the interface component 120 can be coupled to or associated with a permanent prosthetic device, which can provide the operator with an “implant” that enables control or manipulation of the manually controllable mechanism 102 as disclosed herein.

In the example illustrated in FIG. 2, the interface component 120 is coupled to an underside or palm region of a cast worn about the lower arm of an operator, which cast can be maneuvered by the operator to facilitate engagement with the interface component 110 of FIG. 1, which can be coupled to or otherwise supported about a gear shift lever. In this case, the act of grabbing and gripping the gear shift lever to operate a vehicle can be replaced by simply maneuvering the cast to cause the interface component 120 to interface with and engage the interface component 110 (e.g., “palming”). The manual interface system 100 can therefore enable tactile or manual control of the manually controllable mechanism 102 (e.g., gear shift lever) by an operator that may otherwise be unable to interface with (e.g., grip) the manually controllable mechanism 102. In addition, coupling the interface component 120 to the structure 104 (e.g., a cast, a splint, a brace, and/or a prosthetic device or implant) can enable loads to be transferred from the operator's body (e.g., arm) into the structure 104 and to the interface component 120 without unduly loading an injured part of the operator's body (e.g., a wrist) protected and/or supported by the structure 104. An injured part of the operator's body can therefore be bypassed by the load path for operating the manually controllable mechanism 102 compared to the typical load path that travels through the injured body part. Thus, by utilizing the manual interface system 100 (e.g., augmenting a cast, a splint, a brace, and/or a prosthetic device or implant with the interface component 120), a driver can safely and effectively operate and maneuver a vehicle even while wearing a cast, a splint, a brace, and/or a prosthetic device or implant. This can enable the driver to continue operating a vehicle for personal or occupational purposes while rehabilitating an injury or dealing with a disability. The manual interface system 100 can provide a non-invasive, non-destructive additive to the operator's cast or rehabilitation apparatus to restore autonomy and independence to the operator who may otherwise need to rely on the transportation services of others.

The interface component 110 can be coupled to the manual interface device in any suitable manner. For example, the interface component 110 can comprise a main body portion 113 having a coupling interface 114 to facilitate coupling the interface component 110 to the manually controllable mechanism 102. In one embodiment, the main body portion 113 can comprise a knob configuration and the coupling interface 114 can comprise a threaded coupling feature. Thus, in this example, the interface component 110 can substitute or replace a gear shift knob of a gear shift lever. Such a knob configuration of the interface component 110 can enable a user not equipped with the interface component 120 to interface with the gear shift lever in the typical manner (e.g., grasping the interface component 110 configured as a substitute shift knob). The gear shift lever can therefore be operated by users equipped or not equipped with the interface component 120 by configuring the interface component 110 to facilitate engagement with the interface component 120 as well as providing a manual interface (e.g., one for grasping).

In other embodiments, the interface component 110 can be configured as a cover that fits over an existing user interface, such as a knob or a handle, of the manually controllable mechanism 102. In this case, the interface component 110 can be configured for ease of installation and removal (e.g., can comprise a clamp, snap, clip-on, or other type of removable coupling arrangement) over an existing gear shift knob. This can enable the gear shift lever to be quickly converted for use by an operator equipped with the interface component 120 (i.e., following attachment of the interface component 110 to the gear shift knob) or by an operator not equipped with the interface component 120 (i.e., following removal of the interface component 110 from the gear shift knob).

In one aspect, the interface components 110, 120 can be magnetically attracted to one another to help maintain engagement of the interface surfaces 111, 121 during operation of the manually controllable mechanism 102 (e.g., while transferring force 103), while also facilitating selective disengagement of the interface surfaces 111, 121 by the operator. For example, the interface component 110 and/or the interface component 120 can include a permanent magnet. In the embodiment illustrated in FIG. 1, the interface component 110 includes a magnet 115 which, along with the recess 112, creates a magnetic basin or receptacle to receive and capture the protrusion of the interface component 120. If one of the interface components 110, 120 includes a permanent magnet, then the other interface component can include a magnetic material, such as a ferromagnetic material. For example, at least a portion of the interface component 120 can be constructed of a ferromagnetic material, which can be attracted to the magnetic field produced by the magnet 115. In one embodiment, both interface components 110, 120 can include a magnet. Oppositely “polarized” materials of the interface component 110 and the interface component 120 can create a temporary bond strong enough to maintain engagement of the interface components 110, 120 during normal operation of the manually controllable mechanism 102 while allowing the operator to separate or disengage the interface components 110, 120 as desired, such as to perform other operational functions. Thus, the attraction between the interface components 110, 120 can be configured or tuned to create a strong connection without requiring excessive force for the operator to remove the interface component 120 from the interface component 110 when an operational task (e.g. a gear change) has been executed so that the operator can return to a resting position or perform other functions (e.g., driving tasks or responsibilities). The type and size of the magnet and/or magnetic material can be selected to tune the strength of the attraction between the interface components 110, 120.

The interface surfaces 111, 121 can have any suitable shape or configuration. As discussed above, the interface surfaces 111, 121 can be configured to transfer force (e.g., lateral force 103) sufficient to operate the manually controllable mechanism 102. In addition, the interface surface 111 and the interface surface 121 can be configured to facilitate relative rotation between the interface components 110, 120. For example, the interface surfaces 111, 121 can comprise curved surfaces to facilitate relative rotation between the interface components 110, 120. Such relative rotation in at least one rotational degree of freedom can provide maneuverability for the operator, such as allowing the operator's arm and hand to move naturally and without straining or discomfort as the manually controllable mechanism 102 is operated. For example, the operator's arm can maintain rotational freedom while having the ability to push or pull with the wrist at a sufficient lateral force 103 to make a gear change. As shown in FIG. 1, the curved interface surfaces 111, 121 can comprise frustoconical surfaces, although any suitable curved interface surfaces can be utilized, such as circular, cylindrical, conical, or spherical surfaces.

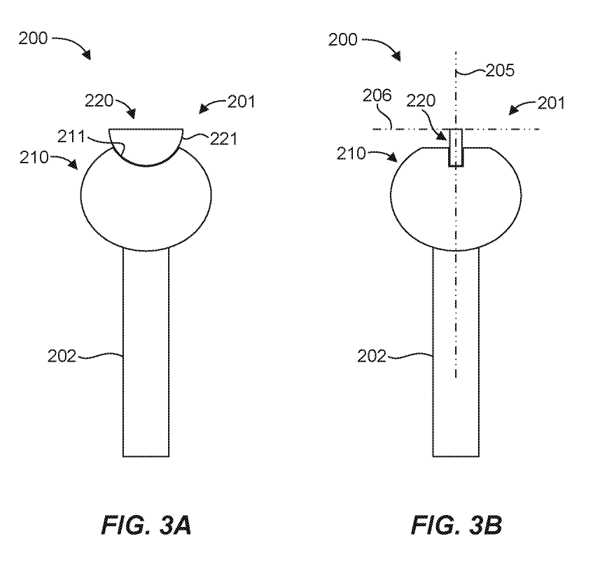

In one aspect, as mentioned above, interface components can be configured to facilitate transfer of torque. For example, as shown in FIGS. 3A and 3B, a manual interface system 200 includes a manual interface device 201 that has an interface component 210 attached to a manually controllable mechanism 202, and an interface component 220 attachable to a human operator as described herein. The interface components 210, 220 are configured to facilitate the transfer of torque. For example, the interface component 210 comprises a keyway at least partially formed by an interface surface 211, and the interface component 220 comprises a key formed at least partially by an interface surface 221. The key and the keyway can be configured to facilitate the transfer of torque between the interface components 210, 220 about an axis 205. In addition, the key and the keyway can be configured to facilitate relative rotation of the interface components 210, 220 about an axis 206, such as by having curved interface surfaces 211, 221.

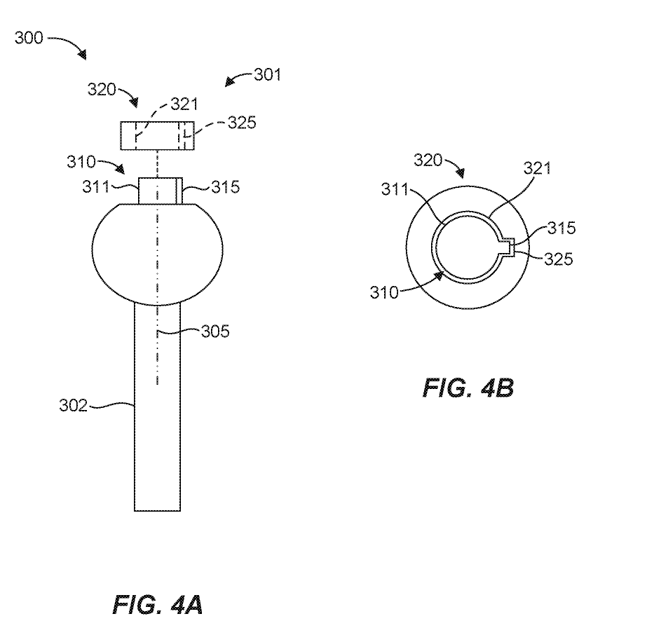

FIGS. 4A and 4B illustrate aspects of a manual interface system 300 in accordance with another example of the present disclosure. The manual interface system 300 includes a manual interface device 301 that has an interface component 310 attached to a manually controllable mechanism 302, and an interface component 320 attachable to a human operator as described herein. The interface component 310 comprises an interface surface 311, and the interface component 320 comprises an interface surface 321. In this case, the interface surfaces 311, 321 are configured as curved cylindrical surfaces. The interface surface 311 defines a protrusion, and the interface surface 321 defines a recess or opening that receives the protrusion.

In one aspect, the interface components 310, 320 can be configured to also facilitate the transfer of torque. For example, the interface component 310 can comprise a key 315, and the interface component 320 can comprise a keyway 325, With the key 315 and the keyway 325, the interface components 310, 320 can form a keyed socket configured to facilitate the transfer of torque between the interface components 310, 320 about an axis 305. Alternatively, the key 315 and the keyway 325 can be omitted and the curved cylindrical interface surfaces 311, 321 can facilitate relative rotation of the interface components 310, 320 about the axis 305.

In accordance with one embodiment of the present invention, a method for facilitating control of a manually controllable mechanism is disclosed. The method can comprise providing a manual interface device having a first interface component attached to the manually controllable mechanism, the first interface component having a first interface surface defining a protrusion or a recess, and a second interface component attachable to a human operator, the second interface component having a second interface surface defining the other of the protrusion or the recess to engage with the first interface surface sufficient to transfer force to operate the manually controllable mechanism. Additionally, the method can comprise facilitating maintaining engagement of the first and second interface surfaces during operation of the manually controllable mechanism and selective disengagement of the first and second interface surfaces by the operator. It is noted that no specific order is required in this method, though generally in one embodiment, these method steps can be carried out sequentially.

In one aspect, the first and second interface components are magnetically attracted to one another to facilitate maintaining engagement of the first and second interface surfaces and selective disengagement of the first and second interface surfaces by the operator. In another aspect, the first interface surface and the second interface surface facilitate relative rotation between the first and second interface components.

It is to be understood that the examples set forth herein are not limited to the particular structures, process steps, or materials disclosed, but are extended to equivalents thereof as would be recognized by those ordinarily skilled in the relevant arts. It should also be understood that terminology employed herein is used for the purpose of describing particular examples only and is not intended to be limiting.

Furthermore, the described features, structures, or characteristics may be combined in any suitable manner in one or more examples. In the description, numerous specific details are provided, such as examples of lengths, widths, shapes, etc., to provide a thorough understanding of the technology being described. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the invention in one or more particular applications, it will be apparent to those of ordinary skill in the art that numerous modifications in form, usage and details of implementation can be made without the exercise of inventive faculty, and without departing from the principles and concepts described herein, Accordingly, it is not intended that the invention be limited, except as by the claims set forth below.

What is claimed is:

1. A method for facilitating control of a manually controllable mechanism, comprising:
providing a manual interface device having
a first interface component attached to the manually controllable mechanism, the first interface component having a first interface surface, and
a second interface component attachable to a human operator, the second interface component having a second interface surface operable to engage with the first interface surface sufficient to transfer force to operate the manually controllable mechanism; and
facilitating engagement of the first and second interface surfaces during operation of the manually controllable mechanism and selective disengagement of the first and second interface surfaces by the operator.

2. The method of claim 1, wherein the first and second interface components are magnetically attracted to one another to facilitate maintaining engagement of the first and second interface surfaces and selective disengagement of the first and second interface surfaces by the operator.

3. The method of claim 1, wherein the first interface surface and the second interface surface facilitate relative rotation between the first and second interface components.

4. The method of claim 1, further comprising configuring the manual interface device with a keyed configuration to facilitate the transfer of torque between the first and second interface components.

5. The method of claim 4, further comprising configuring the first interface component with a key or keyway, and configuring the second interface component with the other of the key or the keyway, thus forming the keyed configuration of the manual interface device.

6. The method of claim 1, further comprising configuring the first interface component with a main body portion having a coupling interface to facilitate coupling the first interface component to the manually controllable mechanism.

7. The method of claim 6, further comprising configuring the main body portion to comprise a knob.

8. The method of claim 6, further comprising configuring the coupling interface to comprise a threaded configuration.

9. The method of claim 1, further comprising configuring the first and second interface surfaces to comprise curved surfaces to facilitate relative rotation between the first and second interface components.

10. The method of claim 9, further comprising configuring the curved surfaces to comprise frustoconical surfaces.
